(19) United States
(12) Patent Application Publication
(10) Pub. No.: US 2024/0055729 A1
(43) Pub. Date: Feb. 15, 2024

(54) NON-AQUEOUS ELECTROLYTE RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Shota UCHIYAMA, Kosai-shi (JP); Kazutaka YOSHIKAWA, Hamamatsu-shi (JP); Shotaro DEGUCHI, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/232,284

(22) Filed: Aug. 9, 2023

(30) Foreign Application Priority Data
Aug. 15, 2022 (JP) 2022-129375

(51) Int. Cl. H01M 50/46; H01M 4/75; H01M 50/446; H01M 10/04

(52) U.S. Cl. CPC H01M 50/46; H01M 4/75; H01M 50/446; H01M 10/0431

(57) ABSTRACT

A non-aqueous electrolyte rechargeable battery includes an electrode body, a negative electrode current collector, and a positive electrode current collector. The electrode body includes a stack of a negative electrode sheet, a positive electrode sheet, and a separator. The negative electrode sheet includes a negative electrode base, a negative electrode mixture layer, and a negative electrode connecting portion. The positive electrode sheet includes a positive electrode base, a positive electrode mixture layer, a positive electrode connecting portion, and an insulating protective layer. The insulating protective layer includes an outer insulating protective layer on a surface relatively far from the positive electrode current collector in a stacking direction of the electrode body and an inner insulating protective layer on a surface relatively close to the positive electrode current collector in the direction. The outer insulating protective layer has a larger thickness than the inner insulating protective layer.

### BACKGROUND

### 1. Field

The present disclosure relates to a non-aqueous electrolyte rechargeable battery, and more particularly, to a non-aqueous electrolyte rechargeable battery that has an insulating protective layer and reduces the load on separators or the like.

### 2. Description of Related Art

Non-aqueous electrolyte rechargeable batteries, such as lithium-ion rechargeable batteries, have a relatively high energy density and a relatively high capacity. Thus, the non-aqueous electrolyte rechargeable battery is used as a power source for driving a battery electric vehicle (BEV), a hybrid electric vehicle (HEV), or the like.

In general, a lithium-ion rechargeable battery is formed by stacking a positive electrode sheet and a negative electrode sheet, and separators to form an electrode body, and by accommodating the electrode body in a battery case filled with electrolyte. Particularly, in recent years, a rolled lithium-ion rechargeable battery having high efficiency and a compact form has been widely used. In this type of battery, a strip-shaped positive electrode sheet, a strip-shaped negative electrode sheet, and separators are stacked. In this state, an electrode body with the stack rolled and compressed in a longitudinal direction is accommodated in a battery case.

The invention disclosed in Japanese Laid-Open Patent Publication No. 2021-089857 includes such an electrode body having a stack including a positive electrode sheet, a negative electrode sheet, and separators. In the electrode body, as shown in FIG. 6A, distal ends of negative electrode connecting portions 103 are aligned to each other, and distal ends of the positive electrode connecting portions 113 are aligned to each other. As shown FIG. 6B, the negative electrode connecting portions 103 at one end of an electrode body 10, which is a current collector, in its width direction W are collectively foiled, and the collectively foiled negative electrode connecting portions 103 are joined to a negative electrode current collector 13. Similarly, the positive electrode connecting portions 113 at the other end are collectively foiled, and the collectively foiled positive electrode connecting portions 113 are respectively joined to a positive electrode current collector 15.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

When the distal ends of the connecting portions are aligned to each other, the collective foiling of the connecting portions causes connecting portions at an outer section to be abruptly bent toward a central portion. Such abrupt bending causes stress to be concentrated on the bent portion. This applies load to a base formed of a metal foil, a mixture layer containing resin, thin resin separators, and the like.

A non-aqueous electrolyte rechargeable battery according to an aspect of the present disclosure includes an electrode body including a stack of a negative electrode sheet, a positive electrode sheet, and a separator disposed between the positive electrode sheet and the negative electrode sheet. The negative electrode sheet includes a negative electrode base formed of a strip-shaped metal foil having a constant width, a negative electrode mixture layer formed on each of opposite surfaces of the negative electrode base, and a negative electrode connecting portion which is formed at one end of the negative electrode base in a width direction and on which the negative electrode mixture layer is not formed. The positive electrode sheet includes a positive electrode base formed of a strip-shaped metal foil having a constant width, a positive electrode mixture layer formed on each of opposite surfaces of the positive electrode base, a positive electrode connecting portion which is formed at an other end of the positive electrode base in the width direction and on which the positive electrode mixture layer is not formed, and an insulating protective layer disposed on each of opposite surfaces of the positive electrode connecting portion at a position that is adjacent to a corresponding one of the positive electrode mixture layers and faces the negative electrode mixture layer. The non-aqueous electrolyte rechargeable battery further includes a negative electrode current collector to which the negative electrode connecting portion at one end of the electrode body in the width direction is collectively foiled and joined and a positive electrode current collector to which the positive electrode connecting portion at an other end of the electrode body in the width direction is collectively foiled and joined. The insulating protective layers respectively formed on the opposite surfaces of the positive electrode connecting portion include an outer insulating protective layer formed on a surface that is relatively far from the positive electrode current collector in a stacking direction of the electrode body and an inner insulating protective layer formed on a surface that is relatively close to the positive electrode current collector in the stacking direction of the electrode body. A thickness of the outer insulating protective layer is larger than a thickness of the inner insulating protective layer.

The thickness of the inner insulating protective layer may be set such that the inner insulating protective layer is bent at a position corresponding to an end of the negative electrode sheet when the positive electrode connecting portion is collectively foiled. In this case, the inner insulating protective layer has a thickness of 11.6 μm or less.

The thickness of the inner insulating protective layer may be set to allow for insulation of the inner insulating protective layer at the position corresponding to the end of the negative electrode sheet when the positive electrode connecting portion is collectively foiled. In this case, the insulating protective layer includes insulator particles made of boehmite and binder made of PVdF, and the inner insulating protective layer has a thickness of 5.0 μm or more when a ratio of a mass of the boehmite to a mass of the PVdF ranges from 70:30 to 90:10.

The thickness of the outer insulating protective layer may be set such that the outer insulating protective layer does not bend outward by an angle greater than or equal to an angle set with respect to an end of the positive electrode mixture layer when the electrode body is bound in a thickness direction to have a reduced thickness from a state in which the positive electrode connecting portion of the electrode body is collectively foiled and joined. In this case, the thickness of the outer insulating protective layer is greater than or equal to a thickness obtained by subtracting a thickness of the positive electrode base from a thickness of the positive electrode mixture layer on a same surface as the outer insulating protective layer of the positive electrode sheet. Further, the thickness of the outer insulating protective layer is less than or equal to a thickness of the positive electrode mixture layer on a same surface as the outer insulating protective layer of the positive electrode sheet.

The electrode body is suitable for a flattened rolled electrode body around which the stack is rolled.

Other features and aspects will be apparent from the following detailed description, the drawings, and the claims.

### BRIEF DESCRIPTION OF DRAWINGS

FIG. 1 is a perspective view showing a cell battery of a lithium-ion rechargeable battery.

FIG. 2 is a schematic diagram showing the configuration of the electrode body that is to be rolled.

FIG. 3 is a perspective view showing an end of the rolled electrode body in the width direction.

FIG. 4 is a schematic diagram showing the configuration of the electrode body of the lithium-ion rechargeable battery.

FIG. 5 is a schematic diagram showing the dimension of each of the positive electrode base, the positive electrode mixture layer, and the insulating protective layer of the positive electrode sheet in the stacked electrode body.

FIG. 6A is a schematic diagram showing the cross-section of the electrode body in which the negative electrode sheets, the positive electrode sheets, and the separators are stacked, as viewed in the direction indicated by line A-A in FIG. 3, in the steps for manufacturing the electrode body of a conventional lithium-ion rechargeable battery.

FIG. 6B is a schematic diagram showing the cross-section of the electrode body in which the negative electrode connecting portions and the positive electrode connecting portions are collectively foiled and welded to the negative electrode current collector and the positive electrode current collector, respectively, as viewed in the direction indicated by line A-A in FIG. 3, in the steps for manufacturing the electrode body of the conventional lithium-ion rechargeable battery.

FIG. 7 is a schematic diagram showing a collective foiling base position for the positive electrode connecting portion of the present embodiment.

FIG. 8 is a schematic diagram showing a collective foiling base position for the positive electrode connecting portion of the prior art.

FIG. 9 is a schematic diagram showing the cross-section of the electrode body in the width direction in a state in which the positive electrode connecting portions are collectively foiled and welded to the positive electrode current collector.

FIG. 10 is a schematic diagram showing the cross-section of the electrode body in the width direction in a state in which the positive electrode connecting portions are collectively foiled and welded to the positive electrode current collector and then pressure is applied to the lithium-ion rechargeable battery to bind the lithium-ion rechargeable battery as a battery stack so that the entire electrode body is compressed in the thickness direction.

FIG. 11 is a schematic diagram illustrating the contact between the outer insulating protective layer and the separator in the present embodiment.

FIG. 12 is a schematic diagram illustrating the contact between the outer insulating protective layer and the separator in the prior art.

FIG. 13 is a perspective view showing a coater used for the insulating protective layer.

FIG. 14 is a schematic diagram illustrating the coating performed on the outer insulating protective layer.

FIG. 15 is a table showing the results of experimental examples.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

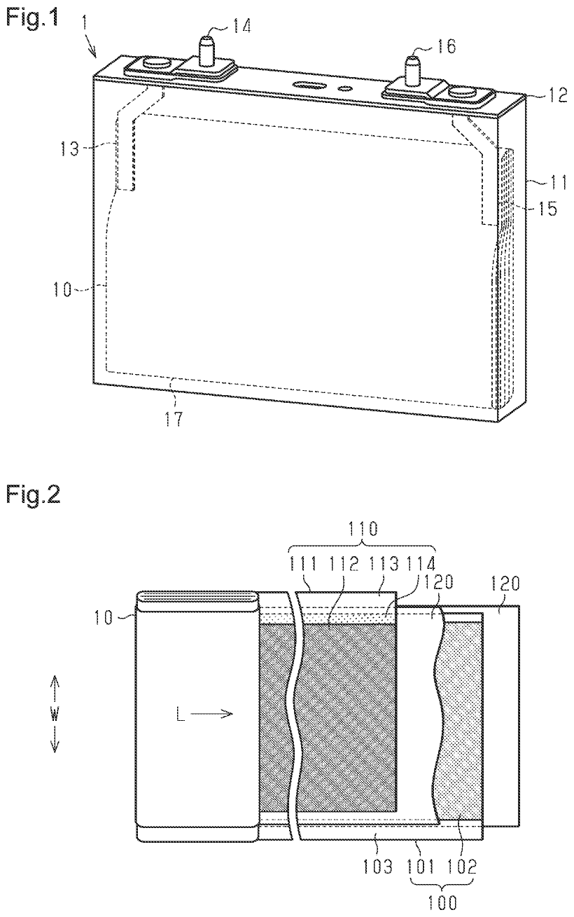

A non-aqueous electrolyte rechargeable battery of the present disclosure will now be described with reference to FIGS. 1 to 15, using an embodiment of a lithium-ion rechargeable battery 1 as an example.

Features of Present Embodiment

An object of the lithium-ion rechargeable battery 1 of the present embodiment is to reduce the load on a positive electrode base 111, a positive electrode mixture layer 112, separators 120, and the like that occurs when positive electrode connecting portions 113 are collectively foiled.

Background Art of Present Embodiment

A conventional electrode body 10, which is background art, will now be described in detail.

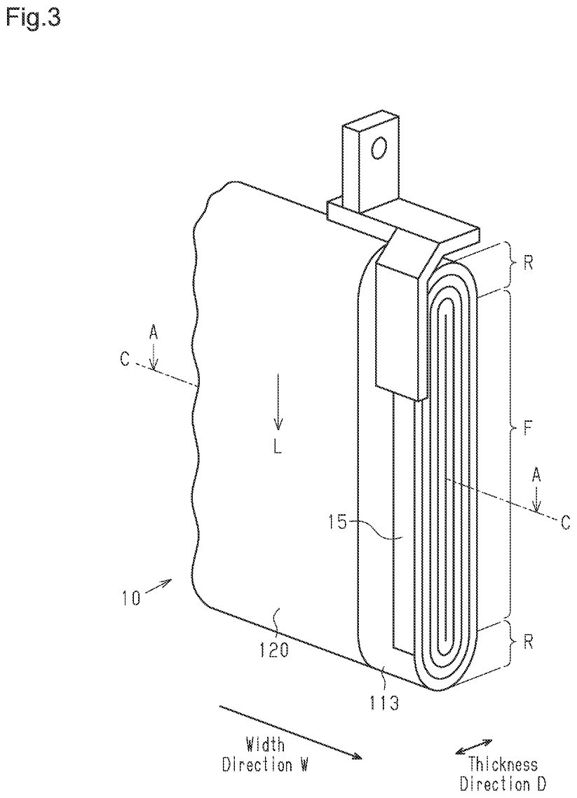

FIG. 2 is a schematic diagram showing the configuration of a rolled electrode body 10. The electrode body 10 is formed by stacking the negative electrode sheet 100, the positive electrode sheet 110, and the separators 120 and rolling the stack. FIG. 3 is a perspective view showing an end of the rolled electrode body 10 in a width direction W. The entire rolled electrode body 10 has a flattened shape, and has a shape like a running track as viewed in the width direction W.

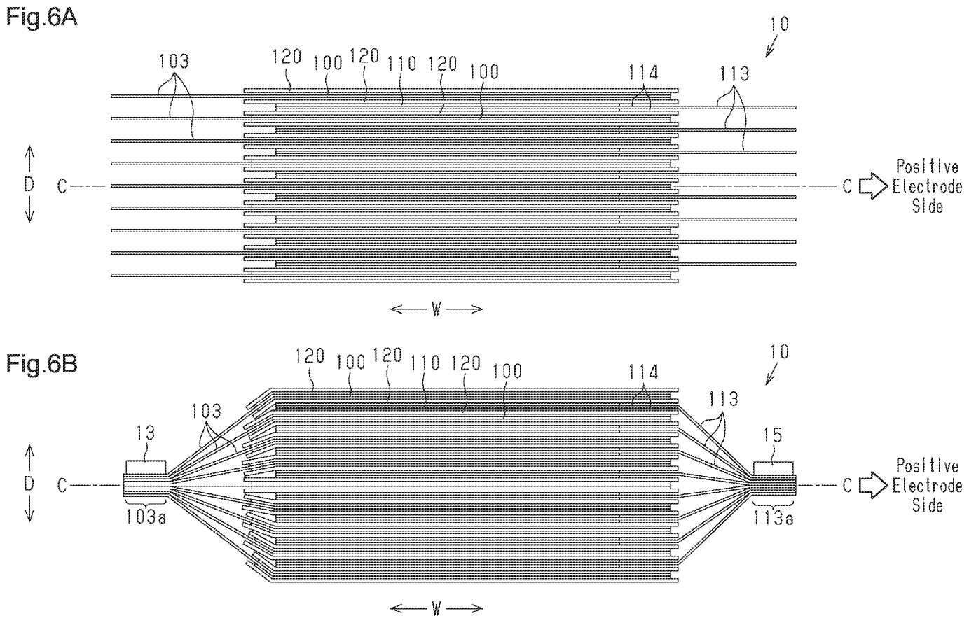

FIG. 6A is a schematic diagram showing the cross-section of the electrode body in which the negative electrode sheet 100, the positive electrode sheets 110, and the separators 120 are stacked, as viewed in the direction indicated by line A-A in FIG. 3, in the steps for manufacturing the electrode body 10 of the conventional rolled lithium-ion rechargeable battery 1. As shown in FIG. 6A, when the negative electrode sheets 100 and the positive electrode sheets 110 are stacked, each negative electrode sheet 100 and a corresponding positive electrode sheet 110 are shifted from each other in the width direction W. Negative electrode connecting portions 103 are also rolled around the electrode body 10 including the rolled stack. The negative electrode connecting portions 103 overlap each other in a thickness direction of the electrode body 10. That is, the negative electrode connecting portions 103 of the electrode body 10 include stacked negative electrode connecting portions 103 that are stacked in the thickness direction of the electrode body 10 (i.e., a negative electrode connecting portion stack). Thus, each of the stacked negative electrode connecting portions 103 (the negative electrode connecting portion stack) in which the negative electrode mixture layer 102 is not disposed and a metal foil is exposed protrudes from one end (the left side in the drawing) of the electrode body 10 in the width direction W. Further, positive electrode connecting portions 113 are rolled around the electrode body 10 including the rolled stack. In the thickness direction of the electrode body 10, the positive electrode connecting portions 113 overlap each other. That is, the positive electrode connecting portions 113 of the electrode body 10 include stacked positive electrode connecting portions 113 that are stacked in the thickness direction of the electrode body 10 (i.e., a positive electrode connecting portion stack). Thus, each of the stacked positive electrode connecting portions 113 (the positive electrode connecting portion stack) on which the positive electrode mixture layer 112 is not formed protrudes from the other one end (the right side in the drawing) of the electrode body 10 in the width direction W. On the positive electrode connecting portion 113, an insulating protective layer 114 is formed at a position that is adjacent to the positive electrode mixture layer 112 and faces the negative electrode mixture layer 102 with the separator 120 arranged in between. Conventionally, the distal ends of the negative electrode connecting portions 103 (the stacked negative electrode connecting portions) are aligned at the same position in the width direction W, and the distal ends of the positive electrode connecting portions 113 (the stacked positive electrode connecting portions) are aligned at the same position in the width direction W.

FIG. 6B is a schematic diagram showing the cross-section of the electrode body 10 in which the negative electrode connecting portions 103 and the positive electrode connecting portions 113 are collectively foiled and welded to the negative electrode current collector 13 and the positive electrode current collector 15, respectively, as viewed in the direction indicated by line A-A in FIG. 3, in the steps for manufacturing the electrode body 10 of the conventional lithium-ion rechargeable battery 1. As shown in FIG. 6B, distal ends 103a of the negative electrode connecting portions 103 and distal ends 113a of the positive electrode connecting portions 113 are compressed and collectively foiled in the thickness direction D. The collectively foiled negative electrode connecting portions 103 are welded between two negative electrode current collectors 13. The collectively foiled positive electrode connecting portions 113 are welded between two positive electrode current collectors 15. As shown in FIG. 1, the negative electrode current collector 13 is exposed to the outside of a battery case 11 through a lid 12 and connected to a negative electrode external terminal 14 on the outside of the lithium-ion rechargeable battery 1. Similarly, the positive electrode current collector 15 is exposed to the outside of the battery case 11 through the lid 12 and connected to a positive electrode external terminal 16 on the outside of the lithium-ion rechargeable battery 1.

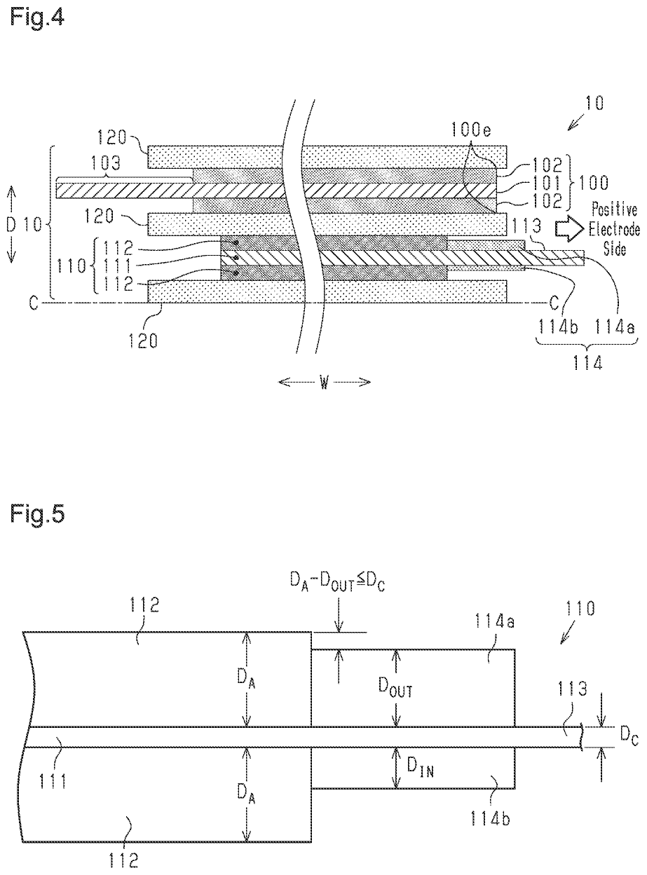

FIG. 4 is a schematic diagram showing the configuration of the electrode body 10 of the lithium-ion rechargeable battery 1. In the negative electrode sheet 100, a negative electrode mixture layer 102 is formed on each of opposite surfaces of a negative electrode base 101 that is formed of, for example, a strip-shaped Cu foil having a constant width. One end (the left side in the drawing) of the negative electrode mixture layers 102 has a negative electrode connecting portion 103. On the negative electrode connecting portion 103, the negative electrode mixture layers 102 are not formed and the negative electrode base 101 is exposed.

The positive electrode sheet 110 is disposed on the negative electrode sheet 100 with the separator 120 located in between. In the positive electrode sheet 110, a positive electrode mixture layer 112 is formed on each of opposite surfaces of a positive electrode base 111 that is formed of, for example, a strip-shaped Al foil having a constant width. The other end (the left side in the drawing) of the positive electrode mixture layers 112 has a positive electrode connecting portion 113. On the positive electrode connecting portion 113, the positive electrode mixture layers 112 are not formed and the positive electrode base 111 is exposed. The dimensions of the positive electrode mixture layers 112 are shorter than the length between the opposite ends of the negative electrode mixture layers 102 in the width direction W, and are formed in a range inside of the opposite ends of the negative electrode mixture layers 102. Thus, a part of the positive electrode connecting portion 113 where the Al foil is exposed faces the negative electrode mixture layer 102 with the separator 120 located in between. Accordingly, in the lithium-ion rechargeable battery 1 of the present embodiment, the insulating protective layers 114 are provided at positions adjacent to the positive electrode mixture layers 112 and facing the negative electrode mixture layers 102 on the opposite surfaces of the positive electrode connecting portion 113, respectively.

On the insulating protective layers 114 respectively formed on the opposite surfaces of the positive electrode connecting portion 113, an insulating protective layer 114 formed on the surface that is relatively far from the positive electrode current collector 15 in the stacking direction (thickness direction) of the electrode body 10 is referred to as an outer insulating protective layer 114a. Further, an insulating protective layer 114 formed on the surface that is relatively close to the positive electrode current collector 15 in the stacking direction (thickness direction) is referred to as an inner insulating protective layer 114b.

Features of Configuration of Insulating Protective Layer 114 of Present Embodiment

FIG. 5 is a schematic diagram illustrating the dimension of each of the positive electrode base 111, the positive electrode mixture layer 112, and the insulating protective layer 114 of the positive electrode sheet 110 in the stacked electrode body 10. The positive electrode base 111 has a thickness D_{C} of approximately 10 to 20 μm, and the positive electrode connecting portion 113 where the positive electrode base 111 is exposed has the same thickness.

The positive electrode mixture layer 112 formed on one side of the positive electrode base 111 has a thickness D_{A} of approximately 15 to 30 μm.

The relationship between a thickness D_{OUT} of the outer insulating protective layer 114a and a thickness D_{IN} of the inner insulating protective layer 114b is represented by the following expression (1).

D_{IN}<D_{OUT} expression (1)

The inner insulating protective layer 114b has the thickness D_{IN} of, for example, 5.0 μm or more and 11.6 μm or less.

The thickness D_{OUT} of the outer insulating protective layer 114a depends on the thickness D_{C} of the positive electrode base 111 and the thickness D_{A} of the positive electrode mixture layer 112, and has the relationship of the following expression (2).

D_{A}−D_{C}≤D_{OUT}≤D_{A} expression (2)

Operation of Present Embodiment

The operation of the present embodiment will now be described.

Operation Gained from Small Thickness D_{IN} of Inner Insulating Protective Layer 114b

Since the thickness D_{IN} of the inner insulating protective layer 114b is smaller than the thickness D_{OUT} of the outer insulating protective layer 114a, the following operation is obtained.

When the thickness D_{IN} of the inner insulating protective layer 114b of the positive electrode connecting portion 113 held between the insulating protective layers 114 is reduced, a bending moment that bends the positive electrode connecting portion 113 inward is generated but is less likely to be bent outward. Further, when the thickness D_{IN} of the inner insulating protective layer 114b is less than or equal to a predetermined value, the inner insulating protective layer 114b is more likely to be bent inward.

The position at which the positive electrode connecting portion 113 is bent toward the positive electrode current collector 15 is referred to as a collective foiling base position P₁.

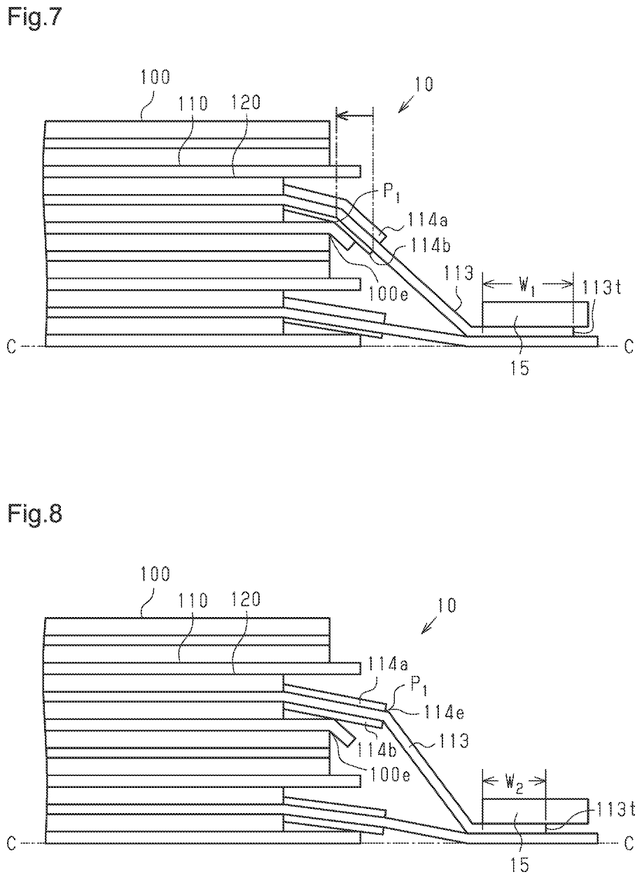

FIG. 8 is a schematic diagram showing the collective foiling base position P₁ of the positive electrode connecting portion 113 of the prior art. To conceptually illustrate the invention, FIG. 8 does not show the section below a center C-C and the left side that are shown in FIG. 6B. Additionally, the number of stacked layers shown is extremely small. The same applies to FIGS. 7 to 10.

As shown in FIG. 8, in the insulating protective layer 114 of the prior art, the thickness D_{OUT} of the outer insulating protective layer 114a and the thickness D_{IN} of the inner insulating protective layer 114b are equal to each other. Each of the thicknesses is formed to be greater than the thickness D_{IN} of the inner insulating protective layer 114b of the present embodiment in order to allow for insulating properties. Thus, each positive electrode connecting portion 113 is less likely to be bent inward. When the positive electrode connecting portions 113 are collectively foiled, each collective foiling base position P₁ where the positive electrode connecting portion 113 is bent serves as an insulating protective layer end 114e. The insulating protective layer end 114e is a coating end of the insulating protective layer 114 where a metal foil is exposed.

FIG. 7 is a schematic diagram showing the collective foiling base position P₁ of the positive electrode connecting portion 113 of the present embodiment. As shown in FIG. 7, the positive electrode connecting portion 113 on which the insulating protective layers 114 are formed is collectively foiled on the positive electrode current collector 15 of the electrode body 10. In this case, the thickness D_{IN} of the inner insulating protective layer 114b is relatively small. Specifically, the thickness D_{IN} of the inner insulating protective layer 114b is, for example, 11.6 μm or less. Thus, the collective foiling base position P₁ of the positive electrode connecting portion 113 serves as a negative electrode slit end 100e of the negative electrode sheet 100 regardless of the insulating protective layer 114.

Thus, the length of the positive electrode connecting portion 113 in the prior art is smaller than the length of the positive electrode connecting portion 113 required for the positive electrode connecting portions 113 in the present embodiment to be collectively foiled on the positive electrode current collector 15. In other words, the position of a distal end 113t of the positive electrode connecting portion 113 shown in FIG. 7 is moved in a distal end direction (moved rightward in FIG. 7) from a position corresponding to the distal end 113t of the positive electrode connecting portion 113 shown in FIG. 8. Thus, a length W1 of the positive electrode current collector 15 of the present embodiment in contact with the positive electrode connecting portion 113 is longer than the length W2 of the positive electrode current collector 15 of the prior art in contact with the positive electrode connecting portion 113. Accordingly, a current collection joining area of the positive electrode current collector 15 at the distal end 113t of the positive electrode connecting portion 113 is relatively large. This improves the conductivity and reduces an internal resistance DC-IR, resulting in an increase in the mechanical strength of welding.

When the inner insulating protective layer 114b of the present embodiment is bent, the separator 120 brings the inner insulating protective layer 114b into contact with the negative electrode slit end 100e. Thus, when the separator 120 is broken, insulation from the negative electrode mixture layer 102 is required. Accordingly, when the positive electrode connecting portions 113 are collectively foiled, the thickness D_{IN} of the inner insulating protective layer 114b is required to be set to allow for insulation of the inner insulating protective layer 114b at a position corresponding to the negative electrode slit end 100e of the negative electrode sheet 100.

In the present embodiment, specifically, the insulating protective layer 114 includes insulator particles made of boehmite and binder made of polyvinylidene fluoride (PVdF). The ratio of the mass of the boehmite to the mass of the PVdF ranges from 70:30 to 90:10. In such a case, insulation is allowed by setting the thickness D_{IN} of the inner insulating protective layer 114b to 5.0 μm or more.

Operation Gained from Large Thickness D_{IN} of Outer Insulating Protective Layer 114a

Since the thickness D_{IN} of the outer insulating protective layer 114a of the lithium-ion rechargeable battery 1 in the present embodiment is relatively large, the following operation is gained.

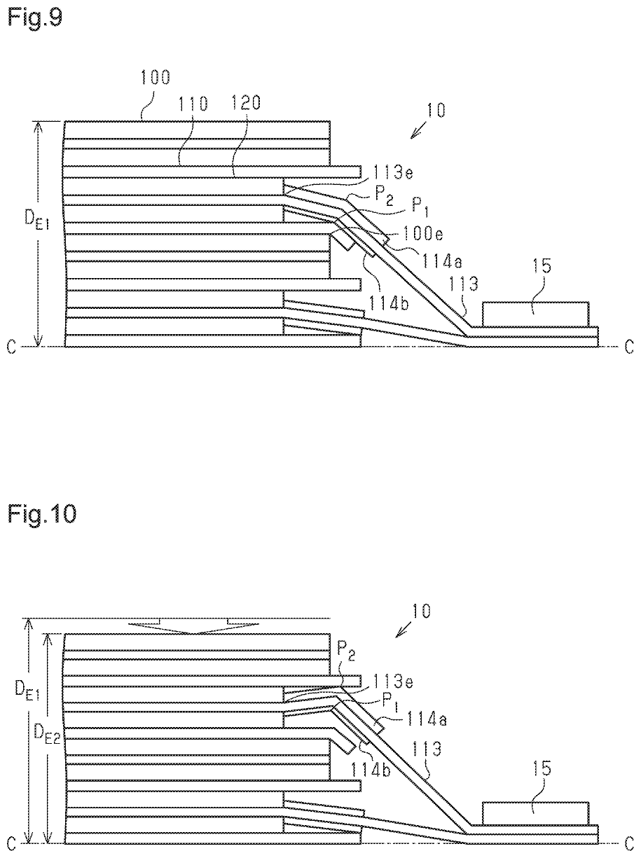

FIG. 9 is a schematic diagram showing the cross-section of the electrode body 10 in the width direction W in a state in which the positive electrode connecting portions 113 are collectively foiled and welded to the positive electrode current collector 15.

As described with reference to FIG. 7, when the positive electrode connecting portions 113 are collectively foiled, in the present embodiment, each positive electrode connecting portion 113 is bent at the collective foiling base position P₁ as the negative electrode slit end 100e of the negative electrode sheet 100. This brings the inner insulating protective layer 114b into contact with the negative electrode slit end 100e with the separator 120 in between.

FIG. 10 is a schematic diagram showing the cross-section of the electrode body 10 in the width direction W in a state in which the positive electrode connecting portions 113 are collectively foiled and welded to the positive electrode current collector 15 and then pressure is applied to the lithium-ion rechargeable battery 1 to bind the lithium-ion rechargeable battery as a battery stack so that the entire electrode body 10 is compressed in the thickness direction D. After the positive electrode connecting portions 113 are collectively foiled and welded to the positive electrode current collector 15 to manufacture the lithium-ion rechargeable battery 1, stacked cell batteries of the lithium-ion rechargeable battery 1 are bound by applying pressure to the cell batteries in the stacking direction with a binding tool. Subsequently, the temperatures of the bound cell batteries are kept relatively high in an aging process or the like.

As shown in FIG. 9, immediately after the positive electrode connecting portions 113 are collectively foiled and welded to the positive electrode current collector 15, the electrode body 10 has a thickness D_{E1}. Then, as shown in FIG. 10, when the electrode body 10 is bound in a high-temperature state in an aging step or the like, the electrode body 10 is compressed to have a thicknesses D_{E2}. In this state, the thickness D_{E1} of the electrode body 10 is compressed to the thickness D_{E2}, however, the length of the positive electrode connecting portion 113 remains unchanged. Thus, an outer bending point P₂ at which the outer insulating protective layer 114a is bent is pushed upward relative to the electrode body 10. This brings the outer bending point P₂ shown in FIG. 9 into contact with the upper (outer) separator 120 as shown in FIG. 10.

FIG. 12 is a schematic diagram illustrating the contact between the outer insulating protective layer 114a and the separator 120 in the prior art. Conventionally, the thickness D_{IN} of the inner insulating protective layer 114b and the thickness D_{OUT} of the outer insulating protective layer 114a are equal to each other, and the thickness D_{OUT} of the outer insulating protective layer 114a is smaller than the thickness D_{OUT} of the present embodiment. This increases the distance between the outer bending point P₂ before bending and the separator 120. Thus, when the outer bending point P₂ comes into contact with the separator 120 after bending, a bending angle θ₂ formed around a positive electrode connecting portion basal end 113e of the positive electrode base 111 becomes relatively large. Accordingly, a relatively large load is applied to the outer insulating protective layer 114a and the positive electrode base 111.

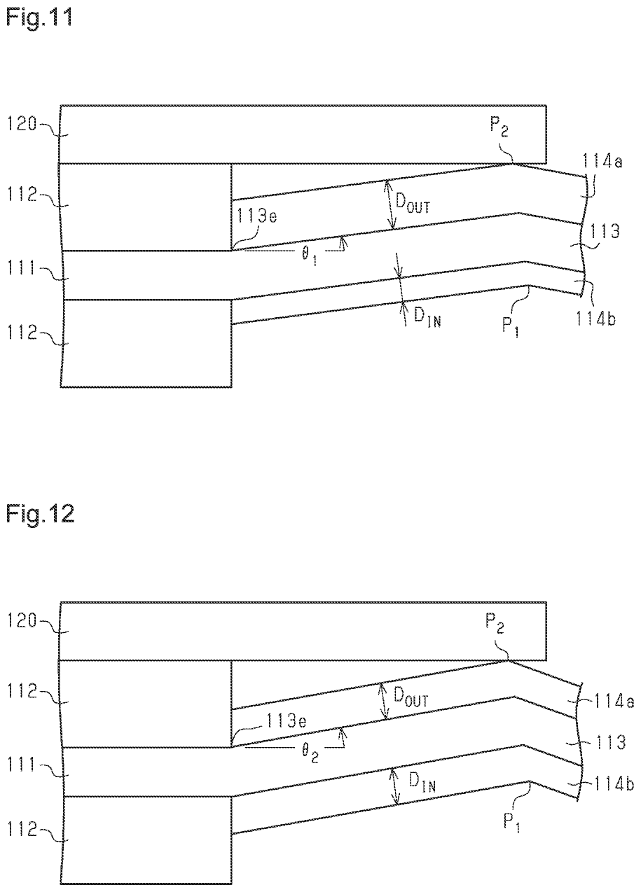

FIG. 11 is a schematic diagram illustrating the contact between the outer insulating protective layer 114a and the separator 120 in the present embodiment. In the present embodiment, the thickness D_{OUT} of the outer insulating protective layer 114a is larger than the thickness D_{IN} of the inner insulating protective layer 114b, and the thickness D_{OUT} of the outer insulating protective layer 114a is larger than the thickness D_{OUT} of the prior art. This reduces the distance between the outer bending point P₂ before bending and the separator 120. Thus, even if the outer bending point P₂ comes into contact with the separator 120 after bending, a bending angle θ₁ formed around the positive electrode connecting portion basal end 113e of the positive electrode base 111 becomes smaller than the bending angle θ₂. Accordingly, a relatively large load is not applied to the outer insulating protective layer 114a or the positive electrode base 111.

Specifically, the thickness D_{OUT} of the outer insulating protective layer 114a depends on the thickness D_{C} of the positive electrode base 111 and the thickness D_{A} of the positive electrode mixture layer 112, and has the relationship of the following expression (2).

D_{A}−D_{C}≤D_{OUT}≤D_{A} expression (2)

Configuration of Embodiment

The configuration of the lithium-ion rechargeable battery 1 according to the present embodiment having the above features will now be described in detail.

Basic Configuration of Lithium-Ion Rechargeable Battery 1

FIG. 1 is a perspective view of the lithium-ion rechargeable battery 1. As shown in FIG. 1, the lithium-ion rechargeable battery 1 includes a cell battery. The lithium-ion rechargeable battery 1 includes a box-shaped battery case 11 having an opening on the upper side of the lithium-ion rechargeable battery 1. The battery case 11 includes the lid 12 that seals the battery case 11. The electrode body 10 is accommodated in the battery case 11. The battery case 11 is filled with a non-aqueous electrolyte 17 from a liquid inlet (not shown). The battery case 11 and the lid 12 are formed from metal such as an aluminum alloy. The lithium-ion rechargeable battery 1 forms a sealed battery jar by attaching the lid 12 to the battery case 11. The lid 12 of the lithium-ion rechargeable battery 1 includes the negative electrode external terminal 14 and the positive electrode external terminal 16, which are used to charge and discharge electric power.

Electrode Body 10

FIG. 2 is a schematic diagram showing the configuration of the rolled electrode body 10. The electrode body 10 is formed by stacking a negative electrode sheet 100, the positive electrode sheet 110, and the separator 120 disposed in between, and rolling the stack in a flattened shape. In the negative electrode sheet 100, the negative electrode mixture layer 102 is formed on the negative electrode base 101. The negative electrode connecting portion 103 in which the negative electrode mixture layer 102 is not formed and the negative electrode base 101 is exposed is disposed at one end of the electrode body 10 in the width direction W (rolling axis direction), which is orthogonal to the direction in which the negative electrode sheet 100 is rolled (rolling direction L). In the positive electrode sheet 110, the positive electrode mixture layer 112 is formed on the positive electrode base 111. The positive electrode connecting portion 113 on which the positive electrode mixture layer 112 is not formed and the positive electrode base 111 is exposed is disposed at the other end of the electrode body 10 in the width direction W (rolling axis direction), which is orthogonal to the direction in which the positive electrode base 111 is rolled (rolling direction L).

End Configuration of Electrode Body 10

FIG. 3 is a perspective view showing an end of the rolled electrode body 10 in the width direction W. The negative electrode sheet 100, the positive electrode sheet 110, and the separators 120 are rolled to form the flattened electrode body 10 having a shape like a running track as viewed in the width direction W. The upper and lower end of the electrode body 10 have a semicircular arc shape. Thus, a curved portion R is formed by the negative electrode sheet 100 and the positive electrode sheet 110. The central portion of the electrode body 10 has a linear shape. Thus, a flat portion F is formed by the negative electrode sheet 100 and the positive electrode sheet 110. In the present embodiment, a straight line of a portion corresponding to the rolling axis is referred to as a center C.

At the other end (the right end in the drawing) of the electrode body 10 in the width direction W shown in FIG. 3, the positive electrode connecting portions 113 are collectively foiled, and electrically and mechanically fixed to the positive electrode current collector 15 through welding. FIG. 3 is merely an example, and another shape may be employed.

Stack of Electrode Body 10

FIG. 4 is a schematic diagram showing the configuration of the stack of the electrode body 10 in the lithium-ion rechargeable battery 1. As shown in FIG. 4, the electrode body 10 of the lithium-ion rechargeable battery 1 includes the negative electrode sheet 100, the positive electrode sheet 110, and the separators 120. The negative electrode sheet 100 includes the negative electrode mixture layers 102 respectively located on the opposite surfaces of the negative electrode base 101. The positive electrode sheet 110 includes the positive electrode mixture layers 112 respectively located on the opposite surfaces of the positive electrode base 111. The negative electrode sheet 100, the positive electrode sheet 110, and the separators 120 are stacked to form the stack. The stack is rolled around the rolling axis in the longitudinal direction to form the electrode body 10 into a flattened shape.

Negative Electrode Sheet 100

As shown in FIG. 4, the negative electrode sheet 100 is formed by forming the negative electrode mixture layers 102 on the respective opposite surfaces of the negative electrode base 101. The negative electrode base 101 is made of a Cu foil in the embodiment. The negative electrode base 101 serves as a base as the aggregate for the negative electrode mixture layers 102, and functions as a current collecting member that collects electricity from the negative electrode mixture layers 102. In the negative electrode sheet 100, the negative electrode mixture layers 102 are formed on the negative electrode base 101, which is made of metal. The negative electrode mixture layers 102 each include a negative active material. In the embodiment, the negative active material is a material capable of storing and releasing lithium ions, and is powder of a carbon material such as graphite.

The negative electrode sheet 100 is formed by, for example, mixing the negative active material, solvent, and binder, applying the mixed negative mixture to the negative electrode base 101, and drying the negative mixture.

Positive Electrode Sheet 110

As shown in FIG. 4, the positive electrode sheet 110 is formed by forming the positive electrode mixture layers 112 on the respective opposite surfaces of the positive electrode base 111. In the present embodiment, the positive electrode base 111 is made of an Al foil or an Al alloy foil. The positive electrode base 111 serves as a base as the aggregate for the positive electrode mixture layers 112, and functions as a current collecting member that collects electricity from the positive electrode mixture layers 112.

In the positive electrode sheet 110, the positive electrode mixture layers 112 are respectively formed on the opposite surfaces of the positive electrode base 111. The positive electrode mixture layers 112 each include a positive active material. The positive active material is a material capable of storing and releasing lithium and is, for example, lithium cobalt oxide (LiCoO₂), lithium manganese oxide (LiMn₂O₄), or lithium nickel oxide (LiNiO₂). The positive active material may also be material in which LiCoO₂, LiMn₂O₄, and LiNiO₂ are mixed in a certain proportion.

The positive electrode mixture layers 112 each include a conductive material. Examples of the conductive material include acetylene black (AB), carbon black such as Ketjenblack®, and graphite.

The positive electrode sheet 110 is formed by, for example, mixing the positive active material, the conductive material, solvent, and binder, applying the mixed positive mixture material to the positive electrode base 111, and drying the positive mixture material.

Separator 120

The separator 120 is a nonwoven fabric made of polypropylene or the like for retaining the non-aqueous electrolyte 17 between the negative electrode sheet 100 and the positive electrode sheet 110. As the separator 120, a porous polymer film (e.g., a porous polyethylene film, a porous polyolefin film, or a porous polyvinyl chloride film) and a lithium-ion-conductive or ion-conductive polymer electrolyte film may be used alone or in combination. When the electrode body 10 is immersed into the non-aqueous electrolyte 17, the non-aqueous electrolyte 17 permeates the separator 120 from its end toward the center.

Insulating Protective Layer 114

In the positive electrode sheet 110 of the present embodiment, the insulating protective layer 114 is formed as described above. In the insulating protective layer 114, insulator particles are fixed in a dispersed state by binder. The insulating protective layer 114 is formed by applying an insulating protective paste to the surface of the positive electrode base 111 along the end of the positive electrode mixture layer 112 and drying the paste.

In the insulating protective paste, a solvent is added to binder to form a liquid and insulator particles are dispersed. Further, a dispersant is added to uniformly disperse the insulator particles in the paste.

The insulator particles are disposed between the negative electrode mixture layer 102 and the positive electrode base 111 (positive electrode connecting portion 113) to achieve electrical insulation. Examples of the insulator particles include ceramics obtained by firing a metal oxide that has high insulating properties and has hardness sufficient to prevent entry of foreign matter. Specifically, particles of boehmite, alumina, or the like are used. In the present embodiment, boehmite is used as the insulator particle.

Boehmite

Boehmite is an aluminum hydroxide (γ-AlO(OH)) mineral, and is a component of aluminum ore (bauxite). Boehmite displays a pearly luster from its vitreous nature, and has a Mohs hardness of 3 to 3.5 and a specific gravity of 3.00 to 3.07. Boehmite has relatively high insulating properties, heat resistance, and hardness. Industrially, boehmite can be used as an inexpensive flame-retardant additive for fire-resistant polymers.

Boehmite is represented by a chemical composition of AlO(OH) or Al₂O₃·H₂O, and is a chemically stable alumina monohydrate generally produced by heating or hydrothermally treating alumina trihydrate in air. Boehmite has a relatively high dehydration temperature of 450 to 530° C., and can be controlled into various shapes such as plate-like boehmite, needle-like boehmite, and hexagonal plate-like boehmite by adjusting production conditions. The adjustment of the production conditions controls aspect ratio and the particle diameter.

Examples of the binder include PVdF, polytetrafluoroethylene (PTFE), polyacrylic acid, and polyacrylate. In the present embodiment, PVdF is used as the binder.

Mixing of Insulation Particles and Binder

In the present embodiment, the insulating protective layer 114 includes insulator particles made of boehmite and binder made of PVdF. The ratio of the mass of the boehmite to the mass of the PVdF ranges from 70:30 to 90:10. In the present embodiment, the thickness D_{IN} of the inner insulating protective layer 114b of the inner insulating protective layers are 5.0 μm or more. Within this range, if the separators 120 are broken and the inner insulating protective layer 114b comes into direct contact with the negative electrode mixture layer 102 at the negative electrode slit end 100e, the insulating properties are allowed. This avoids short-circuiting.

Nonaqueous Electrolyte 17

The non-aqueous electrolyte 17, which is shown in FIG. 1, is a composition in which a non-aqueous solvent contains a supporting salt. The non-aqueous solvent may be ethylene carbonate (EC). Alternatively, the non-aqueous solvent may be one or more materials selected from a group of propylene carbonate (PC), diethyl carbonate (DEC), dimethyl carbonate (DMC), ethyl methyl carbonate (EMC), and the like. The supporting salt may be one or more materials selected from a group of LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like.

Method for Insulating Protective Layer 114

An example of the method for coating the insulating protective layer 114 of the present embodiment will now be described. In the insulating protective layers 114 of the present embodiment, the thickness D_{OUT} of the outer insulating protective layer 114a and the thickness D_{IN} of the inner insulating protective layer 114b are different from each other. The difference in thickness is made by adjusting the viscosity of paste, a solid content ratio NV, a discharge amount and discharge speed of a coater 5, a conveyance speed of the positive electrode base 111, and the like. Further, as described below, the difference between gaps in a die nozzle 51 may be used. Needless to say, these methods may be combined in order to obtain an appropriate thickness.

Configuration of Coating Machine 5

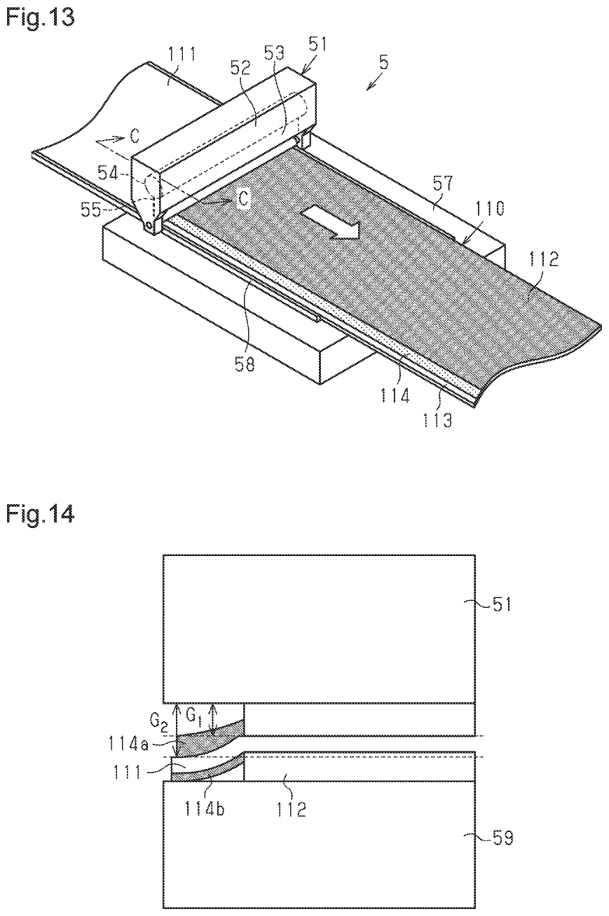

FIG. 13 is a perspective view showing the coater 5 in a coating step of the present embodiment. As shown in FIG. 13, the coater 5 includes a stage 57 serving as a base. The stage 57 includes a positioning guide 58 that conveys an uncut positive electrode base 111, which is made of a strip-shaped Al foil. The positive electrode base 111 is pulled out from a supply reel (not shown) and conveyed on the stage 57 by a conveying means. The die nozzle 51, which has the shape of a gate, is disposed at an upstream end of the stage 57 in the direction in which the positive electrode base 111 is conveyed. The die nozzle 51 is oriented in a direction orthogonal to the conveyance direction, and extends over the positive electrode base 111. The die nozzle 51 includes a first die 52 that stores a positive electrode mixture paste. The first die 52 is a space located in correspondence with the position at which the positive electrode mixture layer 112 is formed. The positive electrode mixture paste is supplied from a supply means (not shown) to the first die 52 and stored in the first die 52. A second die 54 is a space located in correspondence with the position at which the insulating protective layer 114 is formed. The insulating protective paste is supplied from the supply means (not shown) to the second die 54 and stored in the second die 54. The first die 52 and the second die 54 are adjacent to each other on the same straight line.

A first nozzle 53 connects a lower portion of the first die 52 to a position on the stage 57 at which the positive electrode mixture layer 112 of the positive electrode base 111 is formed. When the internal pressure of the first die 52 is increased by a pressurizing means (not shown), a predetermined amount of the positive electrode mixture paste is discharged from the first nozzle 53 to the position at which the positive electrode mixture layer 112 of the positive electrode base 111 is formed.

A second nozzle 55 connects a lower portion of the second die 54 to a position on the stage 57 at which the insulating protective layer 114 of the positive electrode base 111 is formed. When the internal pressure of the second die 54 is increased by a pressurizing means (not shown), a predetermined amount of the insulating protective paste is discharged from the second nozzle 55 to a position at which the insulating protective layer 114 of the positive electrode base 111 is formed. In this manner, the positive electrode mixture layer 112 and the inner insulating protective layer 114b are formed on the inner surface of the positive electrode base 111.

Next, the positive electrode mixture layer 112 and the outer insulating protective layer 114a are formed on the outer side of the positive electrode base 111.

FIG. 14 is a schematic diagram illustrating an example of the coating of the outer insulating protective layer 114a. The coating of the outer insulating protective layer 114a is basically the same as the coating of the inner insulating protective layer 114b, but is different in that a back surface of the outer insulating protective layer 114a is supported by a backup roll 59 instead of the stage 57. When the outer insulating protective layer 114a is coated on the outer surface, the positive electrode mixture layer 112 and the inner insulating protective layer 114b are already formed on the inner surface of the positive electrode base 111 as shown in FIG. 14. In this state, the inner surface of the positive electrode base 111 is brought into contact with the backup roll 59 or the like instead of being brought into contact with the stage 57, and the die nozzle 51 is placed with a spacing of a predetermined gap G₁. Further, the thickness D_{IN} of the inner insulating protective layer 114b is thinner than the thickness D_{A} of the positive electrode mixture layer 112. Thus, when the gap G₁ is provided at a portion of the positive electrode mixture layer 112, the inner insulating protective layer 114b adheres to the backup roll 59 at a portion of the inner insulating protective layer 114b so that the gap G₂ at the portion of the inner insulating protective layer 114b becomes larger than the gap G₁. The gap G₂ is used to make the thickness D_{OUT} of the outer insulating protective layer 114a a predetermined thickness that is greater than the thickness D_{IN} of the inner insulating protective layer 114b. The coating step is not limited to the above method of simultaneous coating. Instead, the positive electrode mixture layer 112 and the insulating protective layer 114 may be formed separately.

Experimental Examples of Present Embodiment

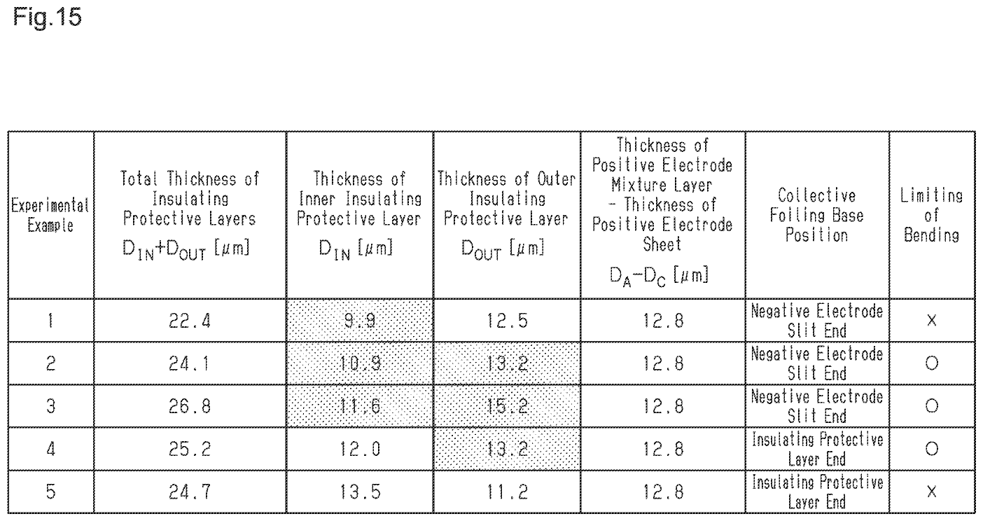

FIG. 15 is a table showing the results of experimental examples. In this experiment, in Experimental Examples 1 to 5, the positive electrode base 111 having a thickness D_{C} of 12 μm and the surface of the positive electrode mixture layer 112 having a thickness D_{A} of 24.8 μm on one side were used. Thus, the value of [the thickness D_{A} of the positive electrode mixture layer 112 on one side—the thickness D_{C} of the positive electrode base 111] was 12.8 μm in common.

In these experiments, evaluation was based on the following four conditions.

Condition 1: In the lithium-ion rechargeable battery 1 of the present embodiment, the relationship between the thickness D_{OUT} of the outer insulating protective layer 114a and the thickness DN of the inner insulating protective layer 114b is D_{IN}<D_{OUT}.

Condition 2: The reference value of the thickness D_{IN} of the inner insulating protective layer 114b is 11.6 μm or less.

Condition 3: The reference value of the thickness D_{IN} of the inner insulating protective layer 114b is 5.0 μm or more.

Condition 4: The thickness D_{OUT} of the outer insulating protective layer 114a is based on the relationship D_{A}-D_{C}≤D_{OUT}≤D_{A}.

Conditions 1 to 4 each indicate a preferred range of the present disclosure, and are not intended to limit the disclosure.

### Experimental Example 1

The total thickness of the insulating protective layers is 22.4 μm, the thickness D_{IN} of the inner insulating protective layer 114b is 9.9 μm, and the thickness D_{OUT} of the outer insulating protective layers 114a is 12.5 μm.

Thus, conditions 1, 2, 3 are satisfied, and the collective foiling base position P₁ is located at the negative electrode slit end 100e. However, since the thickness D_{OUT} of the outer insulating protective layer 114a is less than 12.8 μm, condition 4 is not satisfied. As a result, bending is not sufficiently limited. Consequently, load is applied to the positive electrode base 111 and the separators 120.

### Experimental Example 2

The total thickness of the insulating protective layers is 24.1 μm, the thickness D_{IN} of the inner insulating protective layer 114b is 10.9 μm, and the thickness D_{OUT} of the outer insulating protective layers 114a is 13.2 μm.

Thus, conditions 1, 2, 3, 4 are all satisfied. As a result, the collective foiling base position P₁ is located at the negative electrode slit end 100e. This shortens the path for the collective foiling. Further, bending is sufficiently limited so that the positive electrode base 111 and the separators 120 receive no load.

### Experimental Example 3

The total thickness of the insulating protective layers is 26.8 μm, the thickness D_{IN} of the inner insulating protective layer 114b is 11.6 μm, and the thickness D_{OUT} of the outer insulating protective layers 114a is 15.2 μm.

Thus, conditions 1, 2, 3, 4 are all satisfied. As a result, the collective foiling base position P₁ is located at the negative electrode slit end 100e. This shortens the path for the collective foiling. Further, bending is sufficiently limited so that the positive electrode base 111 and the separators 120 receive no load.

### Experimental Example 4

The total thickness of the insulating protective layers is 25.2 μm, the thickness D_{IN} of the inner insulating protective layer 114b is 12.0 μm, and the thickness D_{OUT} of the outer insulating protective layers 114a is 13.2 μm.

Thus, conditions 1, 3, 4 are satisfied. As a result, bending is sufficiently limited so that the positive electrode base 111 and the separators 120 receive no load. However, the thickness D_{IN} of the inner insulating protective layer 114b is greater than the reference value of 11.6 μm. Thus, the collective foiling base position P₁ is located at the insulating protective layer end 114e so that the foil collecting path cannot be shortened. As a result, the contact area is reduced in the positive electrode current collector 15.

### Experimental Example 5

The total thickness of the insulating protective layers is 24.7 μm, the thickness D_{IN} of the inner insulating protective layer 114b is 13.5 μm, and the thickness D_{OUT} of the outer insulating protective layers 114a is 11.2 μm.

The thickness D_{IN} of the inner insulating protective layer 114b is greater than the thicknesses D_{OUT} of the outer insulating protective layer 114a.

Thus, whereas condition 3 is satisfied, conditions 1, 2, 4 are not satisfied.

As a result, since the collective foiling base position P₁ is located at the insulating protective layer end 114e, the foil collecting path cannot be shortened so that the contact area is reduced in the positive electrode current collector 15. In addition, since bending is not sufficiently limited, load is applied to the positive electrode base 111 and the separators 120.

Summary of Experiments

The above experiments indicate that when conditions 1 to 4 are satisfied, the collective foiling base position P₁ is located at the negative electrode slit end 100e so that the path for the collective foiling is shortened. Further, bending is sufficiently limited so that the positive electrode base 111 and the separators 120 receive no load.

When condition 1 is not satisfied, bending moment acts outward. Thus, it is physically clear that the insulating protective layer 114 is less likely to be bent inward.

When condition 2 is not satisfied, the inner insulating protective layer 114b is less likely to be bent. Thus, since the collective foiling base position P₁ is located at the insulating protective layer end 114e, the path for the collective foiling cannot be shortened. As a result, it was found that the contact area was reduced in the positive electrode current collector 15.

When condition 3 is not satisfied, although not confirmed in these experiments, it is known that the strength of the inner insulating protective layer 114b is problematic.

When condition 4 was not satisfied, it was found that bending could not be sufficiently limited so that the positive electrode base 111 and the separators 120 received load.

It is understood that the level of the total thickness of the insulating protective layers D_{IN}+D_{OUT} is not directly relevant to whether the result is satisfactory, which depends on the thickness D_{IN} of the inner insulating protective layer 114b and the thickness D_{OUT} of the outer insulating protective layer 114a.

As described above, the experiments indicate that Experimental Examples 2, 3 satisfy conditions 1 to 4 and are thus preferred examples of the present embodiment and Experimental Examples 1, 4, 5 are comparative examples of the embodiment. However, the present disclosure is not limited thereto.

Advantages of Present Embodiment

(1) The lithium-ion rechargeable battery 1 of the present embodiment reduces the load on the positive electrode base 111, the positive electrode mixture layer 112, the separators 120, and the like during collective foiling of the positive electrode connecting portions 113.

(2) The thickness D_{OUT} of the outer insulating protective layer 114a formed on the surface that is relatively far from the positive electrode current collector 15 in the stacking direction (thickness direction) of the electrode body 10 is greater than the thickness D_{IN} of the inner insulating protective layer 114b formed on the surface that is relatively close to the positive electrode current collector 15. This allows the positive electrode sheet 110 to be readily bent to approach the positive electrode current collector 15.

(3) In particular, the thickness D_{IN} of the inner insulating protective layer 114b is set such that the inner insulating protective layer 114b is bent at a position corresponding to the end of the negative electrode sheet 100 when the positive electrode connecting portions 113 are collectively foiled. Specifically, the thickness D_{IN} of the inner insulating protective layer 114b is 11.6 μm or less. This shortens the path to the positive electrode current collector 15 and thus increases the contact area on the positive electrode current collector 15.

(4) The thickness D_{IN} of the inner insulating protective layer 114b is set to allow for insulation of the inner insulating protective layer 114b at the position corresponding to the end of the negative electrode sheet 100 when the positive electrode connecting portions 113 are collectively foiled. Specifically, the insulating protective layer 114 includes insulator particles made of boehmite and binder made of PVdF. Further, the ratio of the mass of the boehmite to the mass of the PVdF ranges from 70:30 to 90:10. In this case, the thickness D_{IN} of the inner insulating protective layer 114b is 5.0 μm or less. Thus, even if there is no insulation provided by the separators 120, the insulation of the inner insulating protective layer 114b is allowed at the position corresponding to the end of the negative electrode sheet 100.

(5) The thickness D_{OUT} of the outer insulating protective layer 114a is set such that the outer insulating protective layer 114a is not bent outward by an angle greater than or equal to the set angle θ₁ with respect to the end of the positive electrode mixture layer 112 when the electrode body 10 is bound in the thickness direction D to have a reduced thickness from the state in which the positive electrode connecting portions 113 of the electrode body 10 are collectively foiled and joined. As a result, bending is sufficiently limited so that the positive electrode base 111 and the separators 120 receive no load.

(6) The thickness D_{OUT} of the outer insulating protective layer 114a is greater than or equal to the thickness obtained by subtracting the thickness D_{C} of the positive electrode base 111 from the thickness D_{A} of the positive electrode mixture layer 112 on the same surface as the outer insulating protective layer 114a. Thus, bending is limited effectively.

(7) The thickness D_{OUT} of the outer insulating protective layer 114a is less than or equal to the thicknesses D_{A} of the positive electrode mixture layer 112 on the same surface as the outer insulating protective layer 114a. This prevents the outer insulating protective layer 114a from being thicker than the positive electrode mixture layer 112.

(8) The insulating protective layer 114 of the present embodiment is suitable for the rolled electrode body in which the electrode body 10 is rolled into a flattened shape.

Modifications

The method for coating the insulating protective layer 114 of the present embodiment is merely an example, and is not limited to such a method.

The drawings illustrated in FIGS. 1 to 14 are schematically simplified or deformed to facilitate understanding, and do not limit the present disclosure. The omission of the number of rolls and the number of layers of the electrode body 10, the balance of the thickness, width, and length, the amount of deviation, the angles, and the like are merely examples.

In addition, the numerical ranges exemplified as preferable ranges in the embodiment are merely exemplary. One skilled in the art can optimize the numerical ranges depending on the configuration, material, and the like of the battery.

In the embodiment, the stack is rolled and then flattened. However, the rolled lithium-ion rechargeable battery 1 is not necessarily limited to a stack shaped into a flattened form. The rolled electrode body 10 may be, for example, cylindrical. Furthermore, the electrode body 10 may be a stacked electrode body 10 in which multiple rectangular positive electrode sheets, negative electrode sheets, and separators each having substantially the same shape are stacked. In this case, each of the positive electrode sheets includes the negative electrode connecting portion 103 and the positive electrode connecting portion 113.

The lithium-ion rechargeable battery 1 of the present embodiment is an embodiment of the present disclosure. Needless to say, the present disclosure is not limited to the embodiment, and one skilled in the art can add, delete, or change the configuration without departing from the scope of the claims.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A non-aqueous electrolyte rechargeable battery, comprising:
an electrode body including a stack of a negative electrode sheet, a positive electrode sheet, and a separator disposed between the positive electrode sheet and the negative electrode sheet, wherein
the negative electrode sheet includes
a negative electrode base formed of a strip-shaped metal foil having a constant width,
a negative electrode mixture layer formed on each of opposite surfaces of the negative electrode base, and
a negative electrode connecting portion which is formed at one end of the negative electrode base in a width direction and on which the negative electrode mixture layer is not formed, and
the positive electrode sheet includes
a positive electrode base formed of a strip-shaped metal foil having a constant width,
a positive electrode mixture layer formed on each of opposite surfaces of the positive electrode base,
a positive electrode connecting portion which is formed at an other end of the positive electrode base in the width direction and on which the positive electrode mixture layer is not formed, and
an insulating protective layer disposed on each of opposite surfaces of the positive electrode connecting portion at a position that is adjacent to a corresponding one of the positive electrode mixture layers and faces the negative electrode mixture layer;
a negative electrode current collector to which the negative electrode connecting portion at one end of the electrode body in the width direction is collectively foiled and joined; and
a positive electrode current collector to which the positive electrode connecting portion at an other end of the electrode body in the width direction is collectively foiled and joined, wherein
the insulating protective layers respectively formed on the opposite surfaces of the positive electrode connecting portion include an outer insulating protective layer formed on a surface that is relatively far from the positive electrode current collector in a stacking direction of the electrode body and an inner insulating protective layer formed on a surface that is relatively close to the positive electrode current collector in the stacking direction of the electrode body, and
a thickness of the outer insulating protective layer is larger than a thickness of the inner insulating protective layer.

2. The non-aqueous electrolyte rechargeable battery according to claim 1, wherein the thickness of the inner insulating protective layer is set such that the inner insulating protective layer is bent at a position corresponding to an end of the negative electrode sheet when the positive electrode connecting portion is collectively foiled.

3. The non-aqueous electrolyte rechargeable battery according to claim 2, wherein the inner insulating protective layer has a thickness of 11.6 μm or less.

4. The non-aqueous electrolyte rechargeable battery according to claim 2, wherein the thickness of the inner insulating protective layer is set to allow for insulation of the inner insulating protective layer at the position corresponding to the end of the negative electrode sheet when the positive electrode connecting portion is collectively foiled.

5. The non-aqueous electrolyte rechargeable battery according to claim 4, wherein
the insulating protective layer includes insulator particles made of boehmite and binder made of PVdF, and
the inner insulating protective layer has a thickness of 5.0 μm or more when a ratio of a mass of the boehmite to a mass of the PVdF ranges from 70:30 to 90:10.

6. The non-aqueous electrolyte rechargeable battery according to claim 1, wherein the thickness of the outer insulating protective layer is set such that the outer insulating protective layer does not bend outward by an angle greater than or equal to an angle set with respect to an end of the positive electrode mixture layer when the electrode body is bound in a thickness direction to have a reduced thickness from a state in which the positive electrode connecting portion of the electrode body is collectively foiled and joined.

7. The non-aqueous electrolyte rechargeable battery according to claim 6, wherein the thickness of the outer insulating protective layer is greater than or equal to a thickness obtained by subtracting a thickness of the positive electrode base from a thickness of the positive electrode mixture layer on a same surface as the outer insulating protective layer of the positive electrode sheet.

8. The non-aqueous electrolyte rechargeable battery according to claim 6, wherein the thickness of the outer insulating protective layer is less than or equal to a thickness of the positive electrode mixture layer on a same surface as the outer insulating protective layer of the positive electrode sheet.

9. The non-aqueous electrolyte rechargeable battery according to claim 1, wherein the electrode body is a flattened rolled electrode body around which the stack is rolled.
